(19) United States
(12) Patent Application Publication
(10) Pub. No.: US 2002/0136816 A1
(43) Pub. Date: Sep. 26, 2002

(54) Tablet or powder for producing a carbonated beer beverage

(76) Inventor: Chang S. Kim, Roseburg, OR (US)

Correspondence Address: Robert E. Howard, P. O. Box 10345, Eugene, OR, 97440, US

(21) Appl. No.: 09/816,739

(22) Filed: Mar. 22, 2001

(51) Int. Cl. A23L 2/40

(52) U.S. Cl. 426/591

(57) ABSTRACT

A dry composition capable of generating alcoholic beer in the presence of water. The composition includes agglomerates of an edible carbonation source and a powdered source of alcoholic beer. The edible carbonation source includes a water soluble carbonate and an acid. The source of alcoholic beer is a spray dried solution of beer and a water soluble material such as gelatin or a modified starch. The composition may be used as a free flowing powder or the powder may be compressed into tablet form.

### BACKGROUND OF THE INVENTION

This invention relates to a tablet or powder that can be used for producing a carbonated alcoholic beer beverage by the addition of water to the tablet or powder in a beverage container.

It would desirable for a number of reasons to be able to have a compact source of alcoholic beer, including camping, hiking, commercial aircraft, etc., where weight is at a premium. Such a product would also be useful in restaurants and lounges in order to save space.

Over the years many types of tablets and powders have been suggested for producing a wide variety of carbonated beverages by addition of water to the tablet or powder. Such tablets or powders use powdered flavorants to provide flavoring, such as cola, lemonade, cherry, etc., to the beverage.

However, insofar as is known, no such tablet or powder has been described for producing a carbonated alcoholic beer beverage. The reason is that it is impossible to produce an alcoholic beer powder by evaporating liquid beer since the alcohol will evaporate before the water evaporates.

### SUMMARY OF THE PRESENT INVENTION

It is an object of the present invention to provide a tablet or powder that can be reconstituted into alcoholic beer by the addition of water to the tablet or powder.

This and other objects are achieved by providing a dry composition capable of generating carbonated beer upon exposure to water, the dry composition being comprised of an agglomerated carbonation source and a powdered source of alcoholic beer. The composition may be used in powder form or the powder may be compressed into a tablet.

### DESCRIPTION OF PREFERRED EMBODIMENTS

The dry composition of the present invention is comprised of an agglomerated carbonation source and a powdered source of alcoholic beer.

The agglomerated carbonation source may be any edible composition capable of generating carbon dioxide upon exposure to water. Such a carbonation source could be, for example, a water-soluble carbonate material capable of reacting with an acid or mixture of acids to effect the release of carbon dioxide upon contact with water. The carbonate material may be any sodium or potassium carbonate or bicarbonate, preferably sodium bicarbonate. The acid or mixture of acids can be organic and/or inorganic, such as citric, tartaric, malic, ascorbic and orthophosphoric acids, preferably citric acid.

The powdered components of the carbonation source can be formed into agglomerates by any suitable method. By “agglomerates” is meant a mass of particles, each particle being comprised of individual powders of the components of the carbonation source aggregated together.

One method of producing agglomerates would be to compress the powdered components of the carbonation source into a thin sheet, and crumbling the thin sheet into agglomerates.

Another method of producing agglomerates would be to slightly dampen the surface of the separate powder components with water, blending the components to cause adhesion between adjacent powder particles into agglomerates, drying, and, if necessary, gently breaking up the dried mass to produce agglomerates of the desired size. The amount of water used to dampen the powder components should not be so great as to cause substantial carbonation when the components are mixed together.

Agglomeration creates particles larger than the powders of the individual components of the carbonation source, such larger particles or agglomerates dissolving more slowly in the presence of water than if the components of the carbonation source were left in a purely powdered form.

The size of the agglomerated particles will vary over a wide range, it being preferred that the mass of agglomerates be able to produce continuous carbonation over a period of time, preferably at least five minutes, with the smaller agglomerated particles dissolving substantially immediately and the larger agglomerated particles dissolving last.

The powdered source of alcoholic beer can be formed from a solution of the alcoholic beer and a water soluble material which is spray dried to form a “dry” powder. The water soluble material may be gelatin or one or more modified starches which are easily water soluble. See U.S. Pat. Nos. 3,786,159 and 4,454,165, the disclosures of both of which are incorporated herein by reference. The particle size of the powdered source of alcoholic beer is desirably as small as practical in order that the particles dissolve rapidly upon contact with water.

The agglomerated carbonation source and the powdered source of alcoholic beer are mixed together to form a blend. The agglomerated carbonation source comprises up to about 50% by weight of the blend and the powdered source of alcoholic beer comprises up to about 50% by weight of the blend. It is preferred that the powdered source of alcoholic beer comprises greater than about 50% by weight of the blend, preferably greater than about 75% by weight, and up to about 95% by weight thereof.

The blend may be used as is, or the blend may be compressed into tablets.

In use, the powdered blend or one or more tablets are placed into a beverage container, and water added. The powdered source of alcoholic beer rapidly dissolves, and the agglomerated carbonation source slowly dissolves, releasing carbon dioxide into the beer over an extended period of time. Since the water dilutes the beer, it is preferred to start with a higher alcohol content beer, such as 12%, in forming the powdered beer source.

Alternatively, the blend can be located in a chamber in the beverage container as described in U.S. Pat. No. 4,186,215, the entire contents of which are hereby incorporated by reference.

It will be obvious to those having skill in the art that many changes may be made to the details of the above-described embodiments of this invention without departing from the underlying principles thereof. The scope of the present invention should, therefore, be determined only by the following claims.

The invention claimed is:

1. A dry composition capable of generating carbonated alcoholic beer comprising:
a blend of an edible carbonation source and a source of alcoholic beer;
said edible carbonation source being present as agglomerates having various particle sizes, the smaller particle sizes adapted to rapidly release carbon dioxide in the presence of water and the larger particle sizes adapted to slowly release carbon dioxide in the presence of water;
said source of alcoholic beer being a powder having a particle size adapted to rapidly release beer in the presence of water.

2. The composition of claim 1 wherein said blend is a free-flowing powder.

3. The composition of claim 1 wherein said blend is contained in a tablet.

4. The composition of claim 1 wherein said edible carbonation source is comprised of a first component selected from the group consisting of carbonates or bicarbonates of sodium or potassium and a second component that is an organic or inorganic acid.

5. The composition of claim 4 wherein said acid is selected from the group consisting of citric, tartaric, malic, ascorbic and orthophosphoric acids.

6. The composition of claim 4 wherein said first component is sodium bicarbonate and said second component is citric acid.

7. The composition of claim 1 wherein said source of alcoholic beer is a powder formed by spray drying a solution of an elevated alcohol content beer and a water soluble material selected from the group consisting of gelatin and modified starches.

8. The composition of claim 7 wherein said elevated alcoholic content beer contains about 12% alcohol.
